(19) United States
(12) Patent Application Publication
(10) Pub. No.: US 2004/0118354 A1
(43) Pub. Date: Jun. 24, 2004

(54) Apparatus and method to feed hummingbirds

(76) Inventors: Janine L. Cox, Tucson, AZ (US); Andre B. Cox, Tucson, AZ (US)

Correspondence Address: Dale F. Regelman, Law Office of Dale F. Regelman, P.C., 4231 S. Fremont Avenue, Tucson, AZ, 85714, US

(21) Appl. No.: 10/732,943

(22) Filed: Dec. 11, 2003

Related U.S. Application Data
(60) Provisional application No. 60/432,499, filed on Dec. 11, 2002.

(51) Int. Cl. A01K 7/00

(52) U.S. Cl. 119/72

(57) ABSTRACT

A hummingbird feeder which includes a reservoir comprising a contiguous elastomer and an output port, and liquid hummingbird food disposed in that reservoir. The hummingbird feeder further includes a fluid conduit comprising an elastomer, a first end, and a second end, where that first end can be releaseably attached to the output port.

### FIELD OF THE INVENTION

Applicants' invention relates to an apparatus to feed hummingbirds, and to a method using that apparatus.

### BACKGROUND OF THE INVENTION

People who are fortunate enough to live in an area inhabited by hummingbirds often encourage their presence by the use of hummingbird feeders. These feeders are distinct from the conventional feeder in that, rather than the usual dry food consumed by most birds, the hummingbird feeds on simulated nectar. The simulated nectar is formed from water sweetened with sugar and the like. The nectar is normally stored in a reservoir and conveyed to one or more dispensers. Optionally, each such dispenser includes a perch for the hummingbird. In certain prior art hummingbird feeders include one or more simulated flowers formed such that the hummingbird can land and, having a long slender beak, insert that beak into one or more access apertures in the simulated flower and feed.

Prior art hummingbird feeders are designed to store and dispense liquids, typically mixtures of sugar and water, where the storage reservoir is disposed in near vicinity to the one or more fluid dispensers. It is known, however, that in warm climates, mixtures of sugar and water exhibit a tendency to ferment and provide a media for the growth of bacteria, mold and mildew. The results of the chemical reaction and these growths can endanger the health of the birds being fed.

What is needed is a hummingbird feeder that includes a disposable fluid reservoir and/or a hummingbird feeder wherein the fluid reservoir can be kept in a controlled temperature environment. Applicants' apparatus and method provides just such a hummingbird feeder.

### SUMMARY OF THE INVENTION

Applicants invention includes a hummingbird feeder. Applicants' hummingbird feeder includes a first reservoir comprising a contiguous elastomer and an output port, and liquid hummingbird food disposed in that first reservoir. Applicants' hummingbird feeder further includes a fluid conduit comprising an elastomer, a first end, and a second end, where that first end can be releaseably attached to the output port.

### BRIEF DESCRIPTION OF THE DRAWINGS

The invention will be better understood from a reading of the following detailed description taken in conjunction with the drawings in which like reference designators are used to designate like elements, and in which:

FIG. 1 is a perspective view of a first embodiment of Applicants' hummingbird feeder;

FIG. 2 is a perspective view of a second embodiment of Applicants' hummingbird feeder;

FIG. 3 shows a perspective view of the distal end of the elastomeric fluid conduit portion of a third embodiment of Applicant's hummingbird feeder;

FIG. 4 shows a perspective view of the first embodiment of FIG. 1 which includes a lengthy elastomeric fluid flow conduit;

FIG. 5A is a block diagram of a fourth embodiment of Applicants' hummingbird feeder;

FIG. 5B is a block diagram of a fifth embodiment of Applicants' hummingbird feeder;

FIG. 6 is a perspective view showing a first embodiment of an ornamental dispenser element;

FIG. 7 is a perspective view showing a second embodiment of an ornamental dispenser element;

FIG. 8 is a perspective view showing a third embodiment of an ornamental dispenser element;

FIG. 9A shows a side view of the ornamental dispenser of FIG. 8;

FIG. 9B is a side view of the dispenser of FIGS. 8 and 9A showing the internal parts thereto.

### DETAILED DESCRIPTION OF THE PREFERRED EMBODIMENTS

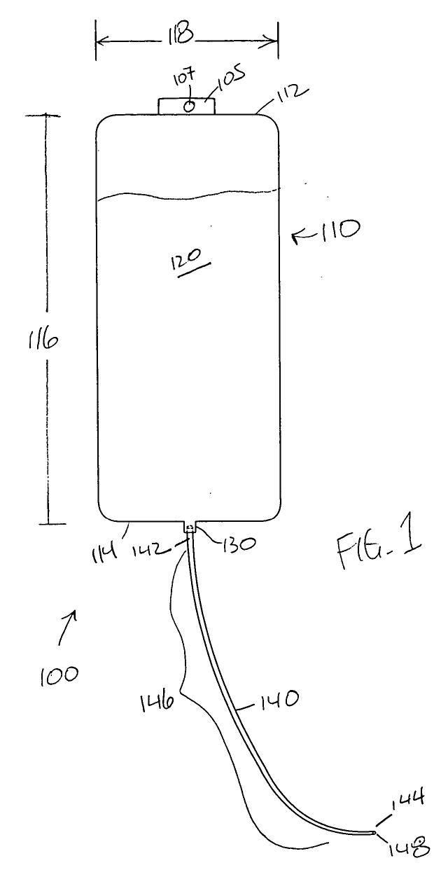

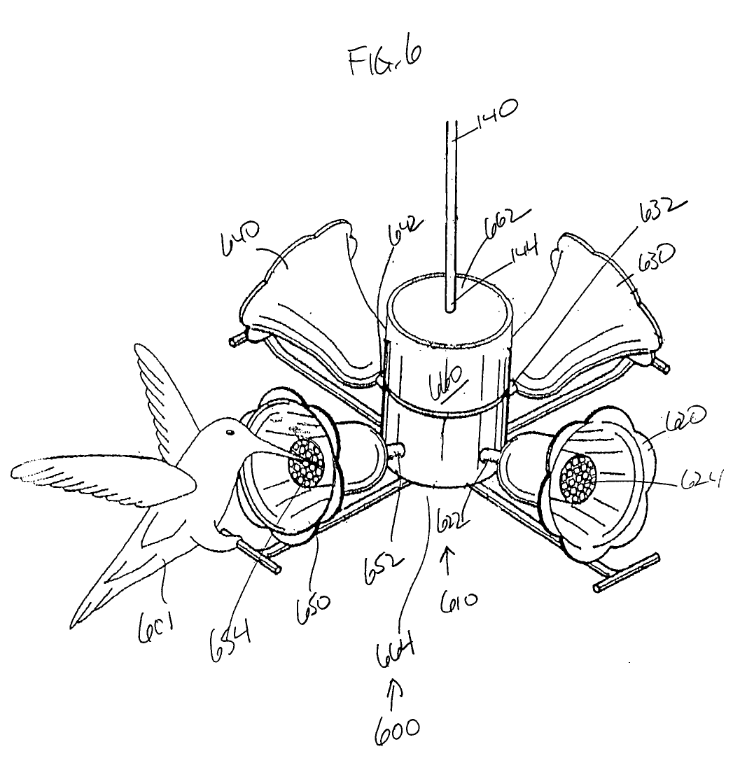

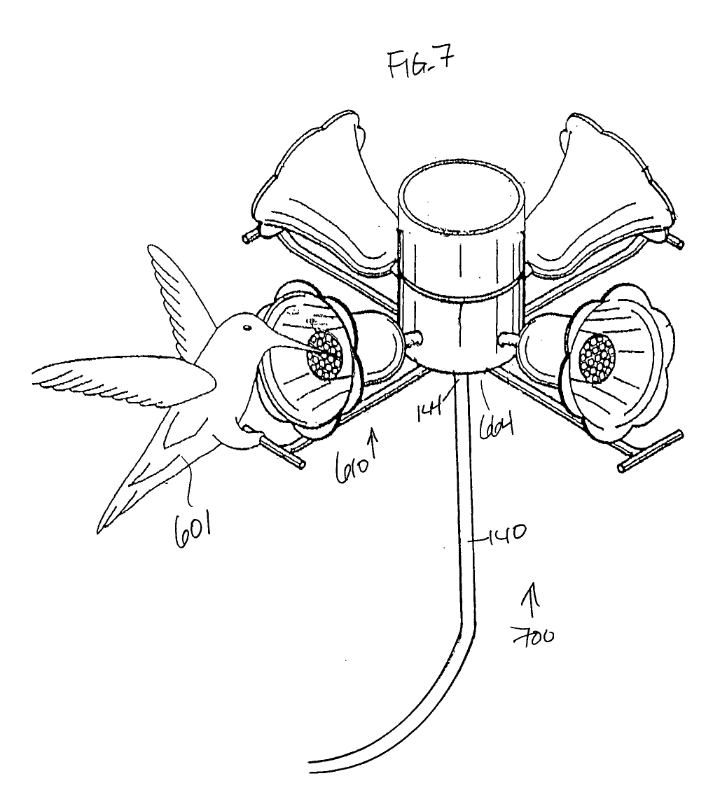

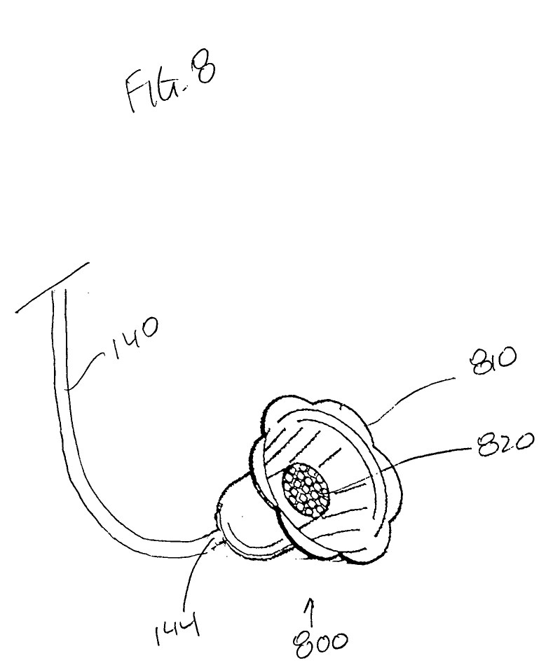

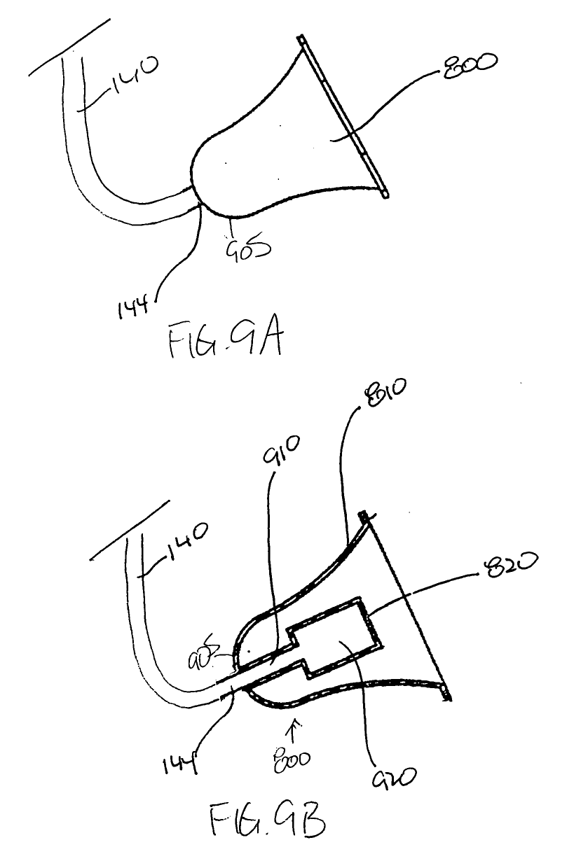

Referring now to FIG. 1, Applicants' apparatus includes reservoir 110, input/output port 130 disposed on one end of reservoir 110, fluid conduit 140, and optionally a dispenser, such as dispenser 610 (FIGS. 6, 7) or 800 (FIGS. 8, 9A, 9B). FIG. 1 shows reservoir 110 partially filled with fluid 120. Fluid 120 comprises hummingbird food. In certain embodiments, fluid 120 comprises a mixture of one or more carbohydrates and water. In certain embodiments, fluid 120 includes one or more coloring agents.

In certain embodiments, reservoir 110 has a volume of about 500 milliliters. In certain embodiments, reservoir 110 has a volume less than about 500 milliliters. In certain embodiments, reservoir 110 has a volume of about 300 milliliters. In certain embodiments, reservoir 110 has a volume of about 1 liter. In certain embodiments reservoir has a volume greater than about 1 liter.

In certain embodiments, reservoir 110 comprises a biodegradable material. By “bio-degradable,” Applicants mean a material that has the proven capability to decompose in the most common environment where the material is disposed within one year through natural biological processes into nontoxic carbonaceous soil, water, or carbon dioxide.

In certain embodiments, reservoir 110 has a cylindrical shape which includes first end 112 and opposing second end 114. In certain embodiments, reservoir 110 comprises a parallelepiped which includes first end 112, second end 114, and a plurality of sides each of which is contiguous with first side 112 and second side 114.

In certain embodiments, first end 112 and second end 114 are substantially equal in dimension, and have a length 118. By “substantially equal,” Applicants mean first side 112 and second side 114 are the same length, plus or minus about ten percent. Reservoir 110 has a second dimension 116 which defines the length of a plurality sides or of a cylindrical body. In certain embodiments, length 116 is greater than length 118. In certain embodiments, length 116 is less than length 118. In certain embodiments, length 116 is substantially equal to length 118.

In certain embodiments, reservoir 110 has a complex shape, such as an inverted cone. In certain embodiments, reservoir has a cylindrical portion in combination with an inverted cone portion, i.e. the shape of an inverted soda bottle. In certain embodiments, reservoir 110 comprises information printed on the exterior surface. In certain embodiments, that information comprises a one or more graphical designs. In certain embodiments, those one or more graphical designs comprises one or more colors.

In certain embodiments, reservoir 110 is formed from an optically transparent material. In certain embodiments, reservoir 110 is formed from an optically opaque material. In certain embodiments, reservoir 110 is formed from a glassy material. By “glassy material,” Applicants mean a material which is substantially non-crystalline. In certain embodiments, such a glassy material has a glass transition temperature greater than room temperature. In certain embodiments, such a glassy material comprises a silicon-oxide material.

In certain embodiments, reservoir 110 is formed from a contiguous, flexible, thin film. In certain embodiments, that thin film comprises an elastomer. By “elastomer,” Applicants mean a material having a glass transition temperature of about −30° C. or lower and/or a room temperature elongation of about 300% or greater. In certain embodiments, such an elastomer is formed from natural rubber. In certain embodiments, such an elastomer is formed from one or more synthetic materials. In certain embodiments, such synthetic materials include, without limitation, plasticized polyvinylchloride, polyurethane, and the like.

In certain embodiments, feeder 100 further comprises an attachment means. In the illustrated embodiment of FIG. 1, attachment means 105 is disposed on end 112 and extends outwardly therefrom. Attachment means 105 includes orifice 107 extending therethrough. As those skilled in the art will appreciate, reservoir 110 can be suspended from an attachment point located on a horizontal, vertical, or sloping member, device, wall, and the like, by releaseably disposing one end of a string, a rope, a rod, a spring, a hook, a nail, a screw, a tack, or the like, through orifice 107, and affixing the other end to the attachment point.

Hummingbird feeder 100 further includes input/output port 130 disposed in end 114. In order to fill feeder 110, reservoir 110 is positioned such that input/output port 130 is disposed at the top of the reservoir. A hummingbird feeding fluid, comprising for example sugar and water, can be disposed in reservoir 110 by gravity feed. In order to dispense that hummingbird feed, reservoir 110 is positioned such that input/output port 130 is located at the bottom of the reservoir.

Applicants' apparatus further includes fluid conduit 140. Conduit 140 includes first end 142, second end 144, middle portion 146, and dispensing aperture 148. First end 142 is capable of being releaseably connected to input/output port 130. In certain embodiments, fluid conduit 140 is formed from an elastomer. In certain embodiments, fluid conduit has an internal diameter of about 1 millimeter. In certain embodiments, fluid conduit 140 has an internal diameter of about 5 millimeters. In certain embodiments, fluid conduit 140 has an internal diameter of about 1 centimeter. In certain embodiments, fluid conduit 140 has an internal diameter greater than about 1 centimeter.

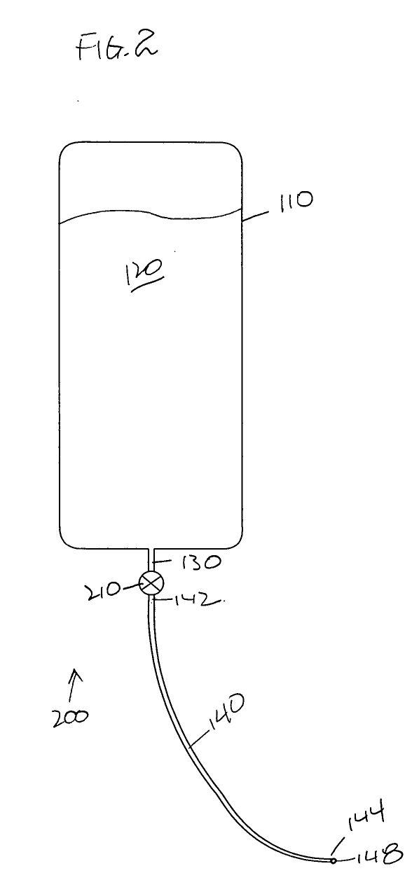

Referring now to FIG. 2, embodiment 200 of Applicants' apparatus includes reservoir 110, input/output port 130, fluid conduit 140, and valve 210. Valve 210 is disposed on the distal end of input/output port 130. End 142 of fluid conduit 140 can be releaseably connected to valve 210. As valve 210 is opened, the flow of hummingbird feed 120 from aperture 148 increases. As valve 210 is closed, the flow of hummingbird feed 120 from aperture 148 decreases. When valve 210 is completely closed, hummingbird feed 120 does not flow from aperture 148.

When the second end 144 of fluid conduit 140 is disposed at a lower gravitational potential than said reservoir 110, i.e. when second end 144 is placed at a first height above the ground and reservoir 110 is placed at a second height above the ground, where the second height is greater than the first height, and when valve 210 is fully opened, liquid hummingbird food 120 flows through conduit 140 and is continuously released from second end 144. As those skilled in the art will appreciate, as liquid food 120 flows through conduit 140 that liquid food experiences a friction force caused by the flow of liquid against the inner surface of conduit 140. As those skilled in the art will further appreciate, that friction force is inversely proportional to the diameter of conduit 140, directly proportional to the length of conduit 140.

Valve 210 can be adjusted such that an equilibrium exists between the gravitational force exerted on feed 120 at aperture 148 and the friction force of feed 120 against the walls of conduit 140, such that one drop of feed 120 remains stationary at aperture 148. When this single drop of feed is consumed by a hummingbird, another drop of feed 120 is formed at, and remains stationary at, aperture 148.

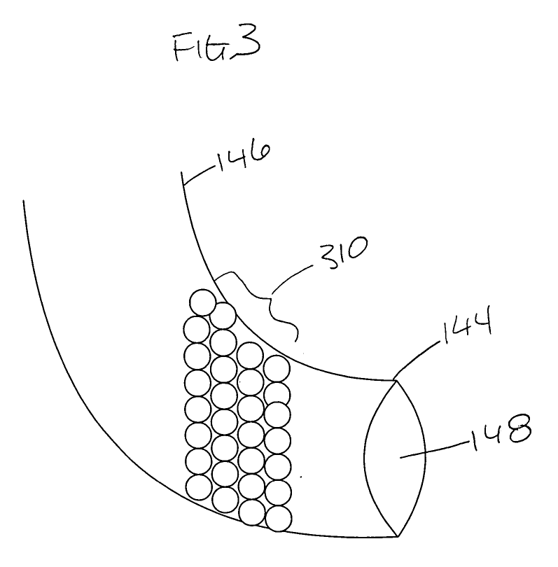

Referring now to FIG. 3, in certain embodiments distal end 144 of fluid conduit 140 includes flow restrictor 310. In certain embodiments, flow restrictor 310 comprises a cellular material having a plurality of individual fluid flow channels disposed therethrough. In the fluid restrictor embodiments, the flow of feed 120 through flow restrictor 310 is limited such a single drop of fluid forms, and remains stationary at, aperture 148. When a hummingbird consumes that single drop of feed, fluid 120 flows through restrictor 310 to form another stationary drop of feed in aperture 148.

In certain embodiments, Applicants' apparatus include valve 210 and fluid flow restrictor 310. In these embodiments, valve 210 and restrictor 310 are adjusted based upon the length of fluid conduit 140, the diameter of fluid conduit 140, and the viscosity of feed 120, such that a stationary drop of feed 120 forms, and remains stationary at, aperture 148.

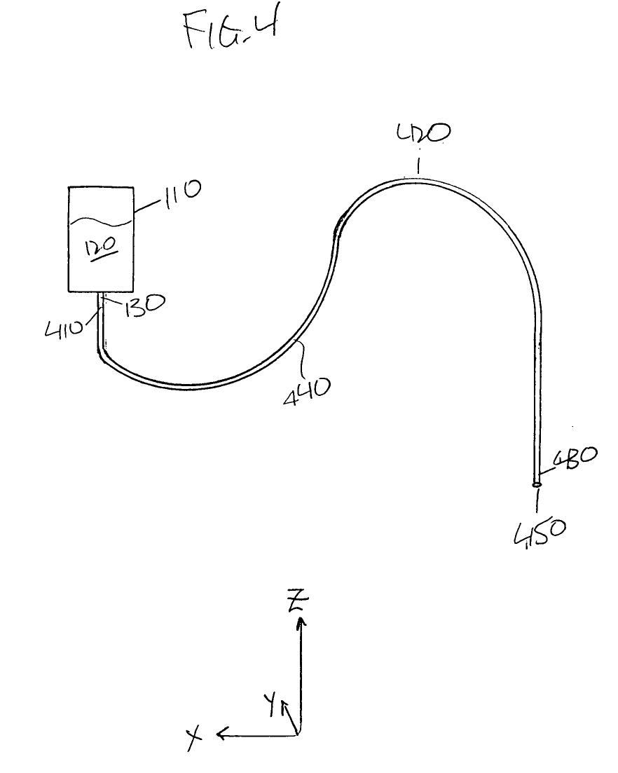

Referring to FIG. 4, in certain applications reservoir 110 is located remotely from aperture 450. In these embodiments, fluid flow conduit 440 can be several feet in length. Point 420 represents the maximum elevation of fluid flow conduit 440 in the +Z direction. As shown in FIG. 4, point 420 is located above input/output port 130. Applicants have found that if aperture 450 remains below the top level of fluid 120, feed 120 can flow from aperture 450 even if portions of fluid flow conduit 420 are higher than the top of the fluid 120 disposed in reservoir 110.

In certain embodiments of Applicants' method, reservoir 110 is disposed within a structure, such as a dwelling, and aperture 450 is located outside that dwelling. For example, reservoir 110 can be located inside a house next to a window. Fluid flow conduit 440 can be routed through a wall, or through a window opening, such that aperture is located outside the house. In these embodiments, reservoir 110 remains inside a temperature controlled environment while the aperture, and hummingbird feed disposed in that aperture, remain available to birds outside the house.

For the convenience of the user, when reservoir 110 is empty, that empty reservoir can be disconnected from end 410 of conduit 440 and discarded. A replacement reservoir, already filled with feed 120, can be connected to the fluid flow conduit. If needed, replacement reservoir 110 can be gently squeezed by hand to start the flow of feed 120 from aperture 450.

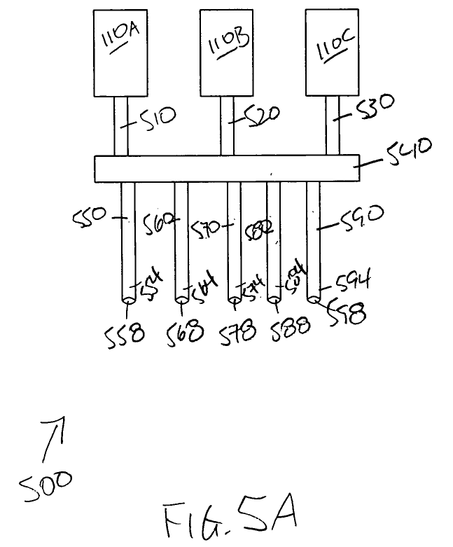

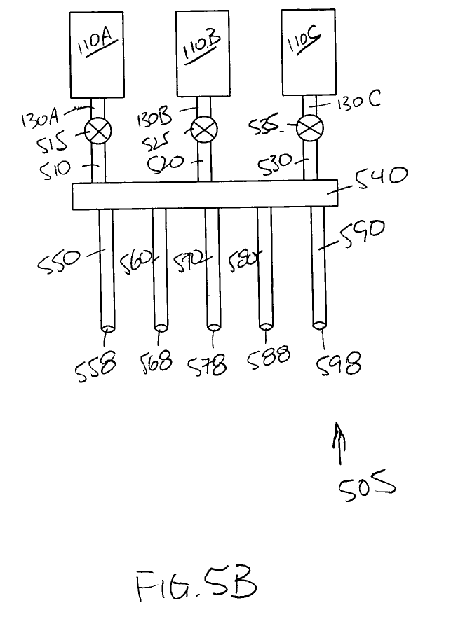

Applicants' apparatus includes embodiments which comprise a plurality of feed reservoirs in combination with a central manifold and a plurality of individual fluid flow conduits connected to that central manifold. For example in the illustrated embodiment of FIG. 5A, Applicants' apparatus 500 includes reservoirs 110A, 110B, and 110C. Reservoir 110A provides feed to manifold 540 by conduit 510. Reservoir 110B provides feed to manifold 540 by conduit 520. Reservoir 110C provides feed to manifold 540 by conduit 530. In certain embodiments, Applicants' apparatus includes two reservoirs. In certain embodiments, Applicants' apparatus includes more than three reservoirs.

In certain embodiments, one or more of conduits 510, 520, and/or 530, are used in combination with a valve, such as valve 210 (FIG. 2). Referring now to FIG. 5B, Applicants' apparatus 505 includes the elements of apparatus 500, and further includes valves 515, 525, and 535. Valve 515 interconnects output port 130A and conduit 510. Valve 525 interconnects output port 130B and conduit 520. Valve 535 interconnects output port 130C and conduit 530.

In the embodiments of FIGS. 5A and 5B, central conduit 540 supplies feed to fluid flow conduits 550, 560, 570, 580, and 590, which dispense feed at apertures 558, 568, 578, 588, and 598, respectively. In certain embodiments, one or more of conduits 550, 560, 570, 580, and/or 590, include a flow restrictor, such as flow restrictor 310, disposed in portions 554, 564, 574, 584, and/or 594, respectively.

In these multiple reservoir embodiments having (N) reservoirs, a continuous flow of feed is assured by releasing feed from up to (N−1) reservoirs at any one time. In these embodiments, there always remains at least one spare reservoir. When any one or more of the (N−1) operational reservoirs empties, the spare reservoir is opened, and the one or more empty reservoirs are replaced. The length of conduits 550, 560, 570, 580, and 590, can be adjusted such that apertures 558, 568, 578, 588, and/or 598 can be located at different places, thereby allowing the feeding of multiple hummingbirds at, in the embodiment of FIGS. 5A and 5B, five different locations. In certain embodiments, Applicants' apparatus includes between 2 and 4 separate dispensing apertures. In certain embodiments, Applicants' apparatus includes more than 5 separate dispensing apertures.

In certain embodiments of Applicants' method, the (N) reservoirs of FIGS. 5A and 5B, the (N) first fluid conduits, and optionally the (M) valves, where (M) is less than or equal to (N), and optionally central manifold 540, are disposed within a structure, such as a dwelling. A plurality of second fluid flow conduits, such as for example conduits 550, 560, 570, 580, and 590, are located outside that dwelling. Fluid flow conduits 550, 560, 570, 580, and 590, can be routed through a wall, or through a window opening, such the dispensing apertures 558, 568, 578, 588, and 598, are located outside the house. In these embodiments, the (N) reservoirs remain inside a temperature controlled environment while the dispensing apertures, and the hummingbird released from those apertures, remain available to birds outside the house.

In certain embodiments, fewer than (N) reservoirs are used to supply food at any certain time. Therefore, there is always at least one reserve reservoir available. For the convenience of the user, when the one or more supplying reservoirs are empty, those empty reservoirs can be disconnected and either refilled or discarded. The reservoir is used to supply food in the interim.

In certain embodiments Applicants' apparatus includes a decorative dispenser connected to the distal end of fluid flow conduit 140. Referring now to FIG. 6, embodiments 600 includes a four dispenser assembly 610 in combination with fluid flow conduit 140. Dispenser 610 includes simulated flowers 620, 630, 640, and 650. Dispenser 610 further includes a perch for each simulated flower dispenser. Hummingbird 601 is shown resting on the perch disposed in near vicinity to flower dispenser 650.

Distal end 144 of fluid flow conduit 140 extends through top portion 662 of assembly 610 and connects to conduits 622, 632, 642, and 652. Conduits 622, 632, 642, and 652, supply feed 120 to feeding apertures 624, 634 (not shown in FIG. 6), 644 (not shown in FIG. 6), and 654, respectively. Referring to FIG. 7, in embodiment 700 distal end 144 of fluid flow conduit 140 extends through bottom portion 664 of assembly 610 and connects to conduits 622, 632, 642, and 652.

Referring now to FIG. 8, in certain embodiments, distal end 144 or conduit 140 is attached to dispenser 800. Dispenser 800 includes a housing 810 and a fluid dispenser 820. In the illustrated embodiment of FIG. 8, housing 810 has the shape of a flower. In the illustrated embodiment of FIG. 8, fluid dispenser 820 comprises a plurality of orifices each of which is in communication with conduit 140.

FIG. 9A shows a side view of dispenser 800. Distal end 144 of conduit 140 extends through end 905 of dispenser 800 and communicates with internal conduit 910. Referring now to FIG. 9B, conduit 910 communicates with assembly 920 which includes fluid dispenser 820 disposed on the distal end. Hummingbird feed, such as fluid 120, flows from reservoir 10 through conduits 140 and 910, and is dispensed at fluid dispenser 820.

While the preferred embodiments of the present invention have been illustrated in detail, it should be apparent that modifications and adaptations to those embodiments may occur to one skilled in the art without departing from the scope of the present invention as set forth in the following claims.

We claim:

1. A hummingbird feeder, comprising:
a first reservoir comprising an output port;
liquid hummingbird food disposed in said first reservoir; and
a fluid conduit comprising an elastomer, a first end, and a second end, wherein said first end can be releaseably attached to said output port.

2. The hummingbird feeder of claim 1, wherein said first reservoir comprises a contiguous elastomer.

3. The hummingbird feeder of claim 2, further comprising a flow restrictor disposed within said fluid conduit adjacent said second end.

4. The hummingbird feeder of claim 3, wherein said flow restrictor comprises a cellular material having a plurality of individual fluid flow channels disposed therethrough.

5. The hummingbird feeder of claim 2, further comprising a valve, wherein said valve is interconnected to said output port, and wherein said first end of said fluid conduit can be releaseably connected to said valve.

6. The hummingbird feeder of claim 1, further comprising:
(N) fluid reservoirs, wherein (N) is greater than or equal to 2;
(N) first fluid conduits;
a central manifold, wherein each of said (N) fluid reservoirs is interconnected to said central manifold via one of said (N) first conduits;
(M) second fluid conduits, wherein each of said (M) second fluid conduits comprises a first end and a second end, wherein the first end of each of said (M) second fluid conduits is interconnected to said central manifold, and wherein (M) may be less than, equal to, or greater than, (N).

7. The hummingbird feeder of claim 6, further comprising:
(P) valves, wherein each of said (P) valves is interconnected to a different one of said (N) fluid reservoirs and to a different one of said (N) first fluid conduits, and wherein (P) is less than or equal to (N).

8. The hummingbird feeder of claim 7, wherein each of said (N) fluid reservoirs comprises a contiguous elastomer.

9. The hummingbird feeder of claim 8, wherein each of said (M) second fluid conduits comprises an elastomer.

10. A method to feed hummingbirds, comprising the steps of:
providing a hummingbird feeder comprising a reservoir which includes an output port, liquid hummingbird food disposed in said reservoir, and an elastomeric fluid conduit comprising a first end and a second end, wherein said second end comprises an aperture;
providing a building;
disposing said reservoir inside said building at a first gravitational potential; and
disposing said second end of said elastomeric fluid conduit outside said building at a second gravitational potential, wherein said first gravitational potential is greater than said second gravitational potential;
releaseably attaching said first end of said conduit to said first reservoir;
providing said hummingbird food from said first reservoir to said aperture.

11. The method of claim 10, wherein said hummingbird feeder further comprises a flow restrictor disposed within said fluid conduit adjacent said second end.

12. The method of claim 11, wherein said flow restrictor comprises a cellular material having a plurality of individual fluid flow channels disposed therethrough.

13. The method of claim 10, wherein said hummingbird feeder further comprises a valve, wherein said valve is interconnected between said first reservoir and said first end of said fluid conduit, further comprising the step of adjusting said valve to create an equilibrium between the gravitational force exerted on said hummingbird food disposed in said first reservoir and the frictional force created by the flow of said liquid hummingbird food through said fluid conduit to form a single drop of hummingbird food disposed at said aperture.

14. The method of claim 10, wherein said reservoir comprises a contiguous elastomer.

15. The method of claim 14, wherein said fluid conduit comprises an elastomer.

16. A method to feed hummingbirds, comprising the steps of:
providing a (N) fluid reservoirs, wherein (N) is greater than or equal to 2;
providing liquid hummingbird food;
disposing said liquid hummingbird food into two or more of said (N) fluid reservoirs;
providing (N) first fluid conduits;
providing a central manifold, wherein each of said (N) fluid reservoirs is interconnected to said central manifold via one of said (N) first conduits;
providing (M) second fluid conduits, wherein each of said (M) second fluid conduits comprises a first end and a second end, wherein (M) may be less than, equal to, or greater than, (N);
interconnecting the first end of each of said (M) second fluid conduits to said central manifold;
dispensing said liquid hummingbird food from one or more of said (M) second ends.

17. The method of claim 16, further comprising the steps of:
providing (P) valves, wherein (P) is less than or equal to (N);
interconnecting each of said (P) valves to a different one of said (N) fluid reservoirs and to a different one of said (N) first fluid conduits.

18. The method of claim 17, further comprising the steps of:
dispensing said liquid hummingbird food from a first one of said (N) fluid reservoirs;
emptying said first fluid reservoir;
dispensing said liquid hummingbird food from a second one of said (N) fluid reservoirs;
refilling said first fluid reservoir;
continuously providing said hummingbird food from one or more of said (N) fluid reservoirs while refilling said first fluid reservoir.

19. The method of claim 18, further comprising the steps of:
providing a building;
disposing said (N) fluid reservoirs inside said building;
disposing the second ends of said (P) second fluid conduits outside of said building.

20. The method of claim 19, wherein each of said (N) fluid reservoirs comprises a contiguous elastomer, and wherein each of said (P) second fluid conduits comprises an elastomer.
